(19) United States
(12) Patent Application Publication
(10) Pub. No.: US 2023/0313479 A1
(43) Pub. Date: Oct. 5, 2023

(54) DEVICE FOR RECOVERING SPILLED OIL

(71) Applicant: KOAI CO., LTD., Busan (KR)

(72) Inventors: Kyung-taek Park, Busan (KR); Ho-sin Lee, Busan (KR); Seul-gi Ju, Gimhae-si (KR); Dong-yeop Lee, Busan (KR)

(73) Assignee: KOAI CO., LTD., Busan (KR)

(21) Appl. No.: 17/968,827

(22) Filed: Oct. 19, 2022

(30) Foreign Application Priority Data
Mar. 29, 2022 (KR) 10-2022-0039047

(51) Int. Cl. E02B 15/10

(52) U.S. Cl. CPC E02B 15/103

(57) ABSTRACT

Disclosed is a spilled oil recovery apparatus, wherein the spilled oil recovery apparatus includes a body configured to provide buoyancy so that the spilled oil recovery apparatus floats on a surface of the sea so as to separate oily water including a mixture of seawater and spilled oil into the seawater and the spilled oil, and a spilled oil storage including a storage body connected to the body so as to store recovered spilled oil, and the body includes an oily water inlet configured to form a space so that the oily water on the sea is introduced into the oily water inlet, a spilled oil separator provided to communicate with the oily water inlet and to separate the spilled oil from the introduced oily water, and a temporary spilled oil storage configured to transfer the spilled oil from the spilled oil separator to the spilled oil storage.

### CROSS-REFERENCE TO THE RELATED APPLICATION

This application claims priority from Korean Patent Application No. 10-2022-0039047, filed on Mar. 29, 2022, in the Korean Intellectual Property Office, the disclosure of which is incorporated herein by reference in its entirety.

### BACKGROUND OF THE INVENTION

### Field of the Invention

The present invention relates to a spilled oil recovery apparatus, and more particularly, to a spilled oil recovery apparatus which may perform spilled oil recovery so as to be suitable for each sea environmental condition and the kind of spilled oil through a spilled oil adsorber having a detachable structure.

### DESCRIPTION OF THE RELATED ART

In the case in which an oil spill accident occurs in seas or rivers, spilled oil and Hazardous and Noxious Substances (HNS) float on the surface of seawater or river water and rapidly spread around, thus causing severe environmental contamination. Therefore, when an oil spill accident occurs, it is important to rapidly remove spilled oil.

In general, when an oil spill happens, a method of sinking spilled oil to the bottom of the sea or the river by spraying an emulsifier onto the surface of water on which the spilled oil floats, a method of removing spilled oil on the coast using an adsorption cloth after contaminants have dispersed to the coast, etc. are used. However, the emulsifier sinks the spilled oil to the bottom of the sea or the river and thus causes secondary contamination, and the method of removing the spilled oil using the adsorption cloth is used after the contaminants have been seriously dispersed, and thus, technology that rapidly recovers the spilled oil immediately after occurrence of oil spill is required.

Recently, in a general method of collecting spilled oil which is used to recover the above-described spilled oil, the spilled oil together with seawater is collected through a floatable pump connected to the end of a support rod connected to a ship, but, in this collection method, in which the spilled oil is collected by the pump at a fixed position connected to the end of the support rod, the ship should be directly moved to a spot where collection of the spilled oil is required, and thus, a lot of time and money are taken and initial response ability is remarkably reduced.

### RELATED ART DOCUMENT

### Patent Document

(Patent Document 0001) Korean Patent Laid-open Publication No. 10-2000-0060103 (Publication Date: Oct. 16, 2000)

### SUMMARY OF THE INVENTION

Therefore, the present invention has been made in view of the above problems, and it is an object of the present invention to provide a spilled oil recovery apparatus which may perform spilled oil recovery so as to be suitable for each sea environmental condition and the kind of spilled oil through a spilled oil adsorber having a detachable structure, and may prevent damage to a propulsion unit and lower structures through propulsion unit protection members provided to surround the propulsion unit even when the spilled oil recovery apparatus is stored in a land environment.

In accordance with the present invention, the above and other objects can be accomplished by the provision of a spilled oil recovery apparatus including a body configured to provide buoyancy so that the spilled oil recovery apparatus floats on a surface of sea, and to separate oily water including a mixture of seawater and spilled oil into the seawater and the spilled oil, and a spilled oil storage including a storage body connected to the body so as to store recovered spilled oil, wherein the body includes an oily water inlet configured to form a space having a designated area at one end of the body so that the oily water on the sea is introduced into the oily water inlet, a spilled oil separator provided to communicate with the oily water inlet so as to separate the spilled oil from the introduced oily water, and a temporary spilled oil storage configured to receive the spilled oil from the spilled oil separator and to transfer the spilled oil to the spilled oil storage.

The spilled oil separator may include a spilled oil adsorber provided to come into contact with the oily water introduced through the oily water inlet and to be rotated so as to selectively adsorb the spilled oil floating on a surface of the oily water, and a scraper provided to come into contact with the spilled oil adsorber and to cover the spilled oil adsorber so as to scrape out the spilled oil adsorbed onto a surface of the spilled oil adsorber and thus to desorb the spilled oil from the spilled oil adsorber, and the spilled oil adsorber may be detachably coupled to the body.

The spilled oil separator may be one selected from a first adsorber and a second adsorber, and the first adsorber and the second adsorber may be configured such that a specific gravity of spilled oil adsorbed by the first adsorber is higher than a specific gravity of spilled oil adsorbed by the second adsorber.

The first adsorber may include at least one dispersion member configured to disperse the spilled oil in an agglomerated state, and, when a plurality of dispersion members is provided, the dispersion members may be disposed to be spaced apart from each other by a designated distance so that protrusions thereof alternate with each other.

The second adsorber may be formed in a cylindrical shape, and may be configured to be rotated while adsorbing the spilled oil on an outer circumferential surface thereof.

The spilled oil recovery apparatus may further include a propulsion unit provided to propel the spilled oil recovery apparatus, and propulsion unit protection members provided on a bottom surface of the body, and configured to surround the propulsion unit so as to space the propulsion unit apart from ground.

The storage body may include at least one folding part provided to fold the storage body in a direction of reducing a length of extension thereof.

The spilled oil storage may include a seawater outlet formed in a bottom surface of the spilled oil storage so as to discharge seawater present in the spilled oil stored in the spilled oil storage, and the seawater outlet may include an opening configured to form an open space having a designated area so that the spilled oil storage communicates with outside therethrough, and a discharge amount adjustment member provided to vary an open area of the opening so as to adjust an amount of seawater discharged through the opening.

The spilled oil outlet may further include a filter provided to surround the opening so as to filter out oil present in the seawater discharged from the spilled oil storage.

The spilled oil storage may include shape maintaining parts provided to surround an outer surface of the storage body so as to maintain a shape of the storage body.

The scraper may include a scraper body formed to cover the spilled oil adsorber, at least one collection member coupled to the scraper body and provided to come into contact with the spilled oil adsorber, and at least one collection channel provided on the scraper body so as to gather and transfer the spilled oil collected by the at least one collection member towards the temporary spilled oil storage.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing a spilled oil recovery apparatus according to one embodiment of the present invention;

FIG. 2 is a plan view showing a body of the spilled oil recovery apparatus according to one embodiment of the present invention;

FIG. 3 is a perspective view showing the detailed configuration of the body of the spilled oil recovery apparatus according to one embodiment of the present invention;

FIGS. 4A and 4B are front views showing the spilled oil adsorber of the spilled oil recovery apparatus according to one embodiment and a spilled oil adsorber of a spilled oil recovery apparatus according to another embodiment of the present invention, respectively;

FIG. 5 is a perspective view showing the detailed configuration of a body of a spilled oil recovery apparatus according to yet another embodiment of the present invention;

FIG. 6 is a plan view showing the detailed configuration of the body of the spilled oil recovery apparatus according to yet another embodiment of the present invention;

FIG. 7 is an enlarged view of portion A of FIG. 6;

FIG. 8 is a side view showing a spilled oil storage of the spilled oil recovery apparatus according to one embodiment of the present invention;

FIG. 9 is a view illustrating the folded state of the spilled oil storage of the spilled oil recovery apparatus according to one embodiment of the present invention;

FIG. 10 is a front view showing the detailed configuration of the spilled oil storage of the spilled oil recovery apparatus according to one embodiment of the present invention;

FIG. 11 is a perspective view showing the detailed configuration of a spilled oil storage of a spilled oil recovery apparatus according to an additional embodiment of the present invention;

FIG. 12 is a front view showing a propulsion unit and propulsion unit protection members of the spilled oil recovery apparatus according to one embodiment of the present invention; and

FIG. 13 is a conceptual view showing an oil recovery system based on monitoring information about a sea environment, including a spilled oil recovery apparatus according to another additional embodiment of the present invention.

### DETAILED DESCRIPTION OF THE INVENTION

Advantages and features of the present invention and methods for achieving the same will become apparent from the descriptions of aspects herein below with reference to the accompanying drawings.

However, the present invention is not limited to the embodiments disclosed herein but may be implemented in various different forms. The embodiments are provided to make the description of the present invention thorough and to fully convey the scope of the present invention to those skilled in the art. It is to be noted that the scope of the present invention is defined only by the claims.

Further, the terminology used herein is for the purpose of describing particular the embodiments only and is not intended to be limiting.

As used herein, singular forms may be intended to include plural forms as well, unless the context clearly indicates otherwise. In the following description of the embodiments, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof.

It is to be noted that, unless defined otherwise, all the terms (including technical and scientific terms) used herein have meanings understood in common by those skilled in the art to which the present invention pertains.

Hereinafter, the present invention will be described with reference to the accompanying drawings.

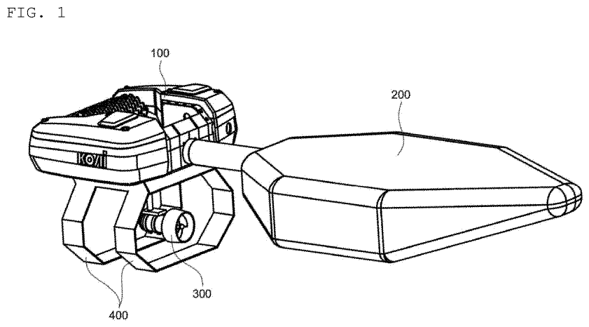

First, referring to FIG. 1, a spilled oil recovery apparatus according to one embodiment of the present invention will be described in detail.

FIG. 1 is a perspective view showing the spilled oil recovery apparatus according to one embodiment of the present invention.

As shown in FIG. 1, the spilled oil recovery apparatus according to one embodiment of the present invention includes a body 100, a spilled oil storage 200, a propulsion unit 300, and propulsion unit protection members 400.

First, the body 100 is configured to provide buoyancy so that the spilled oil recovery apparatus floats on the surface of the sea, and to separate oily water in which seawater and spilled oil are mixed, into the seawater and the spilled oil.

Further, the spilled oil storage 200 includes a storage body 220 connected to the body 100 so as to store recovered spilled oil.

Here, the body 100 includes buoyant bodies provided at both side ends thereof so as to provide buoyancy.

Further, the body 100 includes a power supply and a power generator which are provided in the buoyant bodies so as to operate the spilled oil recovery apparatus.

In addition, a wireless signal receiver configured to receive a signal generated by an external terminal so as to control the spilled oil recovery apparatus in a wireless and unmanned way may be installed in the body 100.

Moreover, a waterproof and watertight structure is applied to the body 100 so as to be suitable for use at sea.

Further, the spilled oil storage 200 is connected to the body 100, and is towed as the body 100 is propelled.

The spilled oil recovery apparatus includes the body 100 and the spilled oil storage 200, which are separated from each other, and may thus secure ease of maintenance of the respective elements, and may resume spilled oil recovery by replacing the spilled oil storage 200 alone rather than the entirety of the spilled oil recovery apparatus with a new one when the spilled oil recovery apparatus is full of the spilled oil, thereby being capable of providing improvement in work efficiency.

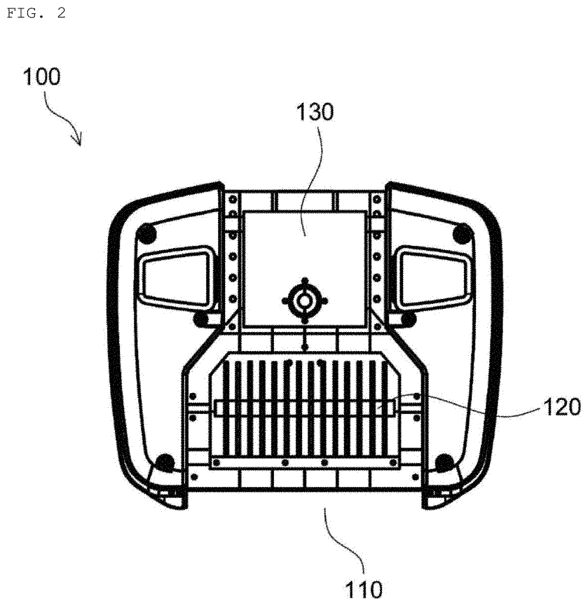

Thereafter, referring to FIG. 2, the body 100 of the spilled oil recovery apparatus according to one embodiment of the present invention will be described in more detail.

FIG. 2 is a plan view showing the body 100 of the spilled oil recovery apparatus according to one embodiment of the present invention.

As shown in FIG. 2, the body 100 of the spilled oil recovery apparatus according to one embodiment of the present invention includes an oily water inlet 110, a spilled oil separator 120, and a temporary spilled oil storage 130.

Here, the oily water inlet 110 forms a space having a designated area at one end of the body 100 so that oily water on the sea is introduced into the oily water inlet 110.

Further, the spilled oil separator 120 is provided to communicate with the oily water inlet 110 and to separate the spilled oil from the introduced oily water.

Moreover, the temporary spilled oil storage 130 receives the separated spilled oil from the spilled oil separator 120, and transfers the spilled oil to the spilled oil storage 200.

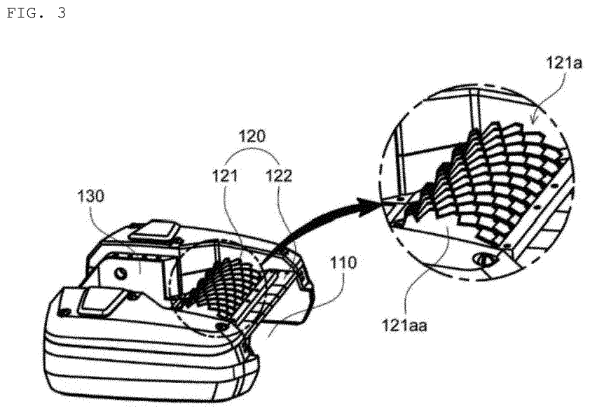

Thereafter, referring to FIG. 3, the spilled oil separator 120 of the body 100 of the spilled oil recovery apparatus according to one embodiment of the present invention will be described in more detail.

FIG. 3 is a perspective view showing the detailed configuration of the body 100 of the spilled oil recovery apparatus according to one embodiment of the present invention.

As shown in FIG. 3, the spilled oil separator 120 of the body 100 of the spilled oil recovery apparatus according to one embodiment of the present invention includes a spilled oil adsorber 121 and a scraper 122.

Here, the spilled oil adsorber 121 comes into contact with the oily water introduced through the oily water inlet 110, and is rotated to selectively adsorb the spilled oil floating on the surface of the oily water.

Further, the spilled oil adsorber 121 is coupled to the body 100 so as to be detachable therefrom.

The spilled oil recovery apparatus includes the spilled oil adsorber 121 configured to be rotated, and thus, the introduced oily water may be adsorbed onto the surface of the spilled oil separator 120 through rotation thereof, thereby being capable of effectively drawing the oily water in a short time.

Further, the spilled oil recovery apparatus includes the spilled oil adsorber 121 detachably coupled to the body 100, and thus, the spilled oil adsorber 121 may be selectively changed depending on the environment and the kind of the oily water, and may be detached from the body 100, thereby being capable of improving ease of maintenance.

The scraper 122 comes into contact with the spilled oil adsorber 121, and covers the spilled oil adsorber 121 so as to scrape out the spilled oil adsorbed onto the surface of the spilled oil adsorber 121 and thus to desorb the spilled oil from the spilled oil adsorber 121.

Further, the scraper 122 may be provided on the spilled oil adsorber 121.

Moreover, the scraper 122 desorbs the spilled oil from the spilled oil adsorber 121, and the desorbed spilled oil flows along the upper surface of the scraper 122 and is introduced into the temporary spilled oil storage 130.

The spilled oil recovery apparatus includes the scraper 122 coming into contact with the spilled oil adsorber 121, and thus, the scraper 122 may come into contact with the surface of the spilled oil adsorber 121 and physically scrape out the spilled oil adsorbed onto the surface of the spilled oil adsorber 121 so as to completely desorb the spilled oil from the spilled oil adsorber 121.

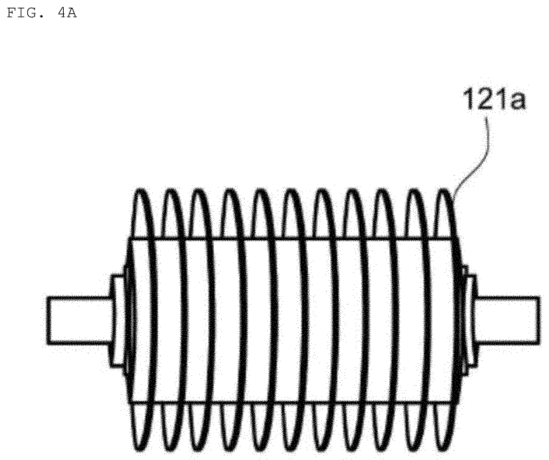

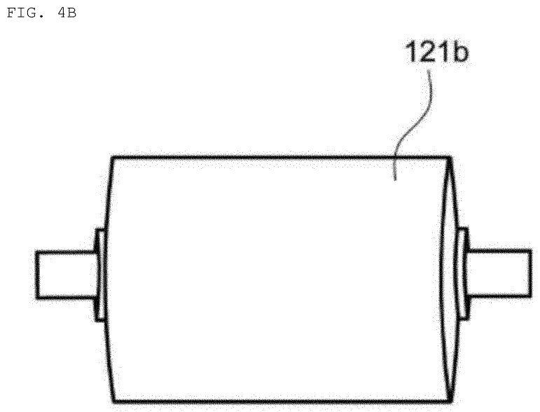

Thereafter, referring to FIG. 3 and FIGS. 4A and 4B, the spilled oil adsorber 121 of the spilled oil recovery apparatus according to one embodiment of the present invention and a spilled oil adsorber 121 of a spilled oil recovery apparatus according to another embodiment of the present invention will be described in more detail.

FIG. 3 is an enlarged view showing the spilled oil adsorber 121 of the spilled oil recovery apparatus according to one embodiment of the present invention, FIG. 4A is a front view showing the spilled oil adsorber 121 of the spilled oil recovery apparatus according to one embodiment of the present invention, and FIG. 4A is a front view showing the spilled oil adsorber 121 of the spilled oil recovery apparatus according to another embodiment of the present invention.

First, as shown in FIGS. 4A and 4B, each of the spilled oil adsorbers 121 of the spilled oil recovery apparatuses according to one embodiment and another embodiment of the present invention may be one selected from a first adsorber 121a and a second adsorber 121b.

Here, the spilled oil adsorbers 121 are provided to be replaceable depending on the specific gravity of the spilled oil.

In more detail, the first adsorber 121a and the second adsorber 121b are characterized in that the specific gravity of spilled oil adsorbed by the first adsorber 121a is higher than the specific gravity of spilled oil adsorbed by the second adsorber 121b.

The spilled oil recovery apparatus includes the spilled oil adsorber 121 selectively employing one of the first adsorber 121a and the second adsorber 121b, and may thus select and replace one of the first adsorber 121a and the second adsorber 121b as the spilled oil adsorber 121 so as to be suitable for the environment and the kind of the oily water, thereby being capable of improving spilled oil recovery efficiency.

Thereafter, as shown in FIG. 3, the first adsorber 121a includes at least one dispersion member 121aa configured to disperse the spilled oil in an agglomerated state, and, when a plurality of dispersion members 121aa is provided, the dispersion members 121aa are disposed to be spaced apart from each other by a designated distance so that protrusions thereof alternate with each other.

Here, the dispersion members 121aa may include circular discs.

Further, in the dispersion members 121aa, the protrusions, which protrude in the centrifugal direction from the centers of the discs, and depressions, which are depressed in the centripetal direction from the outer circumferential surfaces of the discs, are alternately formed, and thus, the dispersion members 121aa may be formed to have a serrated shape.

Here, the protrusions may extend to form a designated angle of inclination from the depressions.

The spilled oil recovery apparatus includes the first adsorber 121a including at least one dispersion member 121aa, and may thus physically disperse the spilled oil, thereby being capable of effectively performing oil-water separation even in an environment in which the viscosity of the spilled oil is high.

Further, the second adsorber 121b is formed in a cylindrical shape, and is rotated while adsorbing the spilled oil on the outer circumferential surface thereof.

The spilled oil recovery apparatus includes the second adsorber 121b formed in the cylindrical shape, and may thus effectively perform oil-water separation even in an environment in which the viscosity of the spilled oil is low.

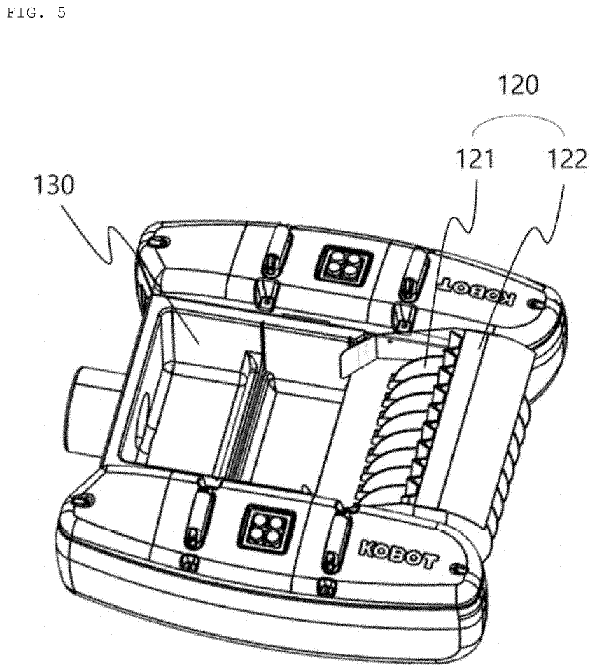

Thereafter, referring to FIGS. 5, 6 and 7, a scraper 122 of a body 100 of a spilled oil recovery apparatus according to yet another embodiment of the present invention will be described in more detail.

In the description of yet another embodiment of the present invention, a part of the construction and operation of this embodiment is substantially the same as the above-described earlier embodiment, and a detailed description thereof will thus be omitted because it is considered to be unnecessary.

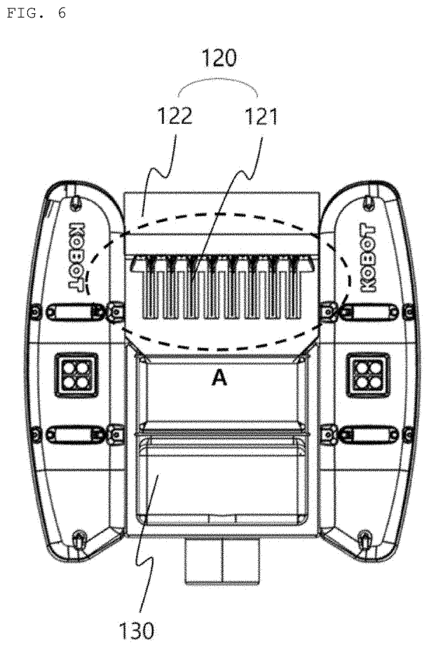

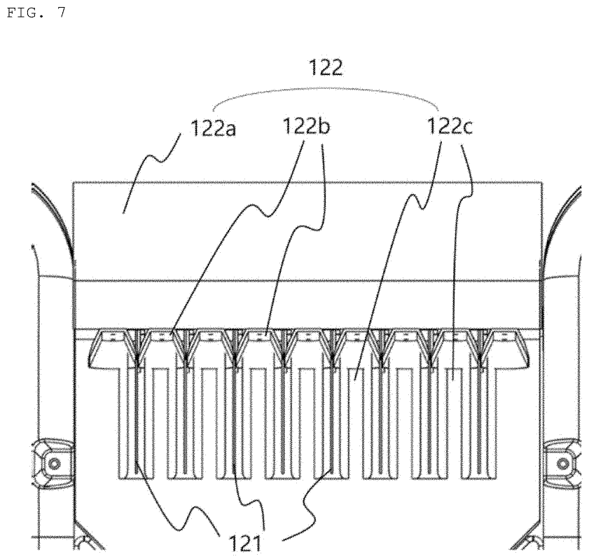

FIG. 5 is a perspective view showing the detailed configuration of the body 100 of the spilled oil recovery apparatus according to yet another embodiment of the present invention, FIG. 6 is a plan view showing the detailed configuration of the body 100 of the spilled oil recovery apparatus according to yet another embodiment of the present invention, and FIG. 7 is an enlarged view of portion A of FIG. 6.

First, as shown in FIGS. 5 and 6, the scraper 122 may be provided on a spilled oil adsorber 121 so as to come into contact with the spilled oil adsorber 121 and to cover the spilled oil adsorber 121.

Further, the scraper 122 is provided to physically scrape out the spilled oil adsorbed onto the surface of the spilled oil adsorber 121 so as to desorb the spilled oil from the spilled oil adsorber 121.

As shown in FIG. 7, the scraper 122 may include a scraper body 122a, collection members 122b, and collection paths 122c.

Here, the scraper body 122a is formed to cover the spilled oil adsorber 121.

The collection members 122b are coupled to the scraper body 122a, and are provided to come into contact with the spilled oil adsorber 121.

Further, the collection members 122b are provided to physically scrape out the spilled oil adsorbed onto the surface of the spilled oil adsorber 121, and the surface of the spilled oil adsorber 121 may include the outer circumferential surface, the side surfaces, etc. of the spilled oil adsorber 121.

Here, at least one collection member 122b may be provided to improve the recovery rate of the spilled oil.

Further, the collection member 122b may include a surface which is bent from a part of the collection member 122b coupled to the scraper body 122a towards the temporary spilled oil storage 130, and extends.

Here, at least one bent surface may be provided such that the end thereof comes into contact with the side surface of the spilled oil adsorber 121.

For example, the collection members 122b may be disposed to alternate with the dispersion members 121aa provided in plural so that the bent surfaces of the collection members 122b recover the spilled oil adsorbed onto the side surfaces of the dispersion members 121aa.

The spilled oil recovery apparatus includes the collection members 122b provided to come into contact with the spilled oil adsorber 121, thereby being capable of improving individual contact areas of the collection members 122b with the spilled oil adsorber 121 and improving the recovery rate of the spilled oil adsorbed onto the side surfaces of the spilled oil adsorber 121.

Further, the collection channels 122c are provided on the scraper body 122a so as to gather and transfer the spilled oil collected by the collection members 122b towards the temporary spilled oil storage 130.

Here, at least one collection channel 122c may be provided to smoothly transfer the collected spilled oil.

The collection channels 122c are characterized in that one end of each of the collection channels 122c is connected to the tip of a corresponding one of the collection members 122b, and the other end of each of the collection channels 122c is connected to the temporary spilled oil storage 130.

Moreover, the collection channels 122c are provided in a number corresponding to the number of the collection members 122b.

The side ends of the collection channels 122c may be bent in a direction of surrounding the spilled oil so as to prevent the spilled oil collected by the collection members 122b from being discharged to other regions during movement of the spilled oil towards the temporary spilled oil storage 130.

Further, the collection channels 122c may be bent to have a designated angle of inclination so that the spilled oil may be easily moved from the collection members 122b towards the temporary spilled oil storage 130.

The spilled oil recovery apparatus includes the collection channels 122c provided to move the collected spilled oil towards the temporary spilled oil storage 130, and may thus form flow paths for the spilled oil collected by the collection members 122b, thereby being capable of preventing the spilled oil from leaking to other regions and improving the recovery rate of the spilled oil.

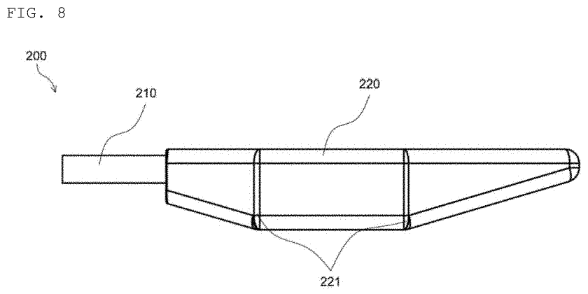

Thereafter, referring to FIG. 8, the spilled oil storage 200 of the spilled oil recovery apparatus according to one embodiment of the present invention will be described in more detail.

FIG. 8 is a side view showing the spilled oil storage 200 of the spilled oil recovery apparatus according to one embodiment of the present invention.

As shown in FIG. 8, the spilled oil storage 200 of the spilled oil recovery apparatus according to one embodiment of the present invention includes a spilled oil inlet 210 and the storage body 220.

Here, the spilled oil inlet 210 is characterized as forming a spilled oil transfer path which transmits the spilled oil discharged from the temporary spilled oil storage 130.

Further, a screw-type feed method may be applied to the spilled oil inlet 210.

The inside of the spilled oil inlet 210 is coated with a nano-material so as to prevent the spilled oil from being adhered to the inner tube of the spilled oil inlet 210, thereby being capable of increasing the recovery rate of the spilled oil.

The storage body 220 is connected to the spilled oil inlet 210 so as to accommodate the spilled oil.

Further, the storage body 220 may be formed of a material which easily floats on water, such as polyester, PVC, or the like.

The storage body 220 may include a porous structure configured to prevent sloshing through reduction in pressure applied to the inner wall of the storage body 220.

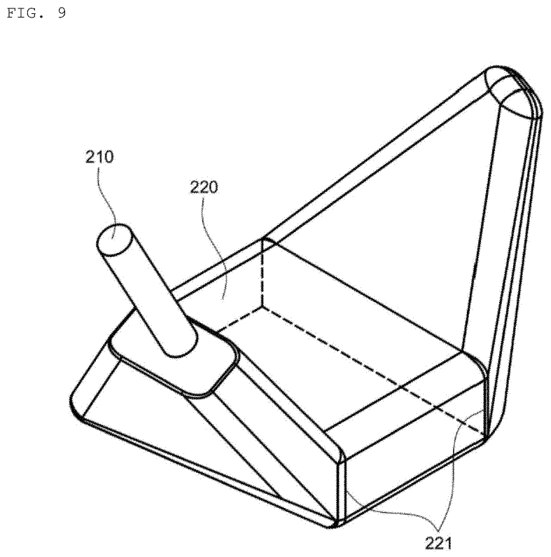

Therefore, referring to FIG. 9, the folded state of the spilled oil storage 200 of the spilled oil recovery apparatus according to one embodiment of the present invention will be described in more detail.

FIG. 9 is a view illustrating the folded state of the spilled oil storage 200 of the spilled oil recovery apparatus according to one embodiment of the present invention.

As shown in FIG. 9, the storage body 220 includes folding parts 221.

Here, at least one folding part 221 is provided to fold the storage body 220 in a direction of reducing the length of extension thereof.

Further, the storage body 220 may be folded in the upward direction along the folding parts 221, as shown in this figure, or, conversely, may be folded in the downward direction along the folding parts 221, although not shown in this figure.

The storage body 220 may be folded along the folding parts 221 when the storage body 220 is stored and transported, and may be unfolded again to be returned to the original shape thereof when the storage body 220 floats on the sea so as to store the spilled oil.

The spilled oil recovery apparatus includes the folding parts 221 provided such that the storage body 220 is folded in the length direction therealong, and may thus allow the spilled oil storage 200 to be folded, thereby being capable of facilitating storage and transportation of the spilled oil storage 200.

Further, since the storage body 220 may be unfolded again along the folding parts 221 to be returned to the original shape of the storage body 220, the volume of the spilled oil storage 200 may be flexibly adjusted depending on each situation, and thus, more efficient space utilization may be achieved.

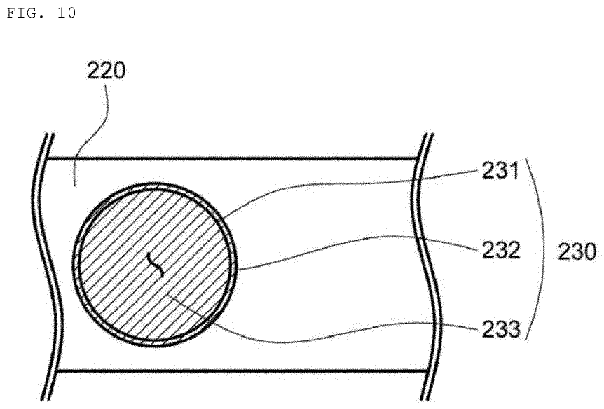

Thereafter, referring to FIG. 10, the detailed configuration of the spilled oil storage 200 of the spilled oil recovery apparatus according to one embodiment of the present invention will be described in more detail.

FIG. 10 is a front view showing the detailed configuration of the spilled oil storage 200 of the spilled oil recovery apparatus according to one embodiment of the present invention.

As shown in FIG. 10, the spilled oil storage 200 includes a seawater outlet 230.

The seawater outlet 230 is characterized as being formed in the bottom surface of the spilled oil storage 200 so as to discharge seawater present in the spilled oil.

Here, the seawater outlet 230 includes an opening 231, a discharge amount adjustment member 232, and a filter 233.

The opening 231 is characterized as forming an open space having a designated area so that the spilled oil storage 200 communicates with the outside therethrough.

Further, the discharge amount adjustment member 232 is provided to vary the open area of the opening 231 so as to adjust the amount of seawater discharged through the opening 231.

The discharge amount adjustment member 232 may be provided to open and close the opening 231 in a sliding manner.

The spilled oil recovery apparatus includes the discharge amount adjustment member 232 provided to open and close the opening 231, and may thus adjust the discharge amount of seawater by opening and closing the opening 231, thereby being capable of flexibly adjusting the amount of seawater discharged from the spilled oil recovery apparatus depending on a sea environment and condition and thus increasing propulsion efficiency of the spilled oil recovery apparatus.

Further, the filter 233 is provided to surround the opening 231 so as to filter out oil present in seawater discharged from the spilled oil storage 200.

The filter 233 may employ a nano-mesh net so as to increase the filtration rate of oil from the discharged seawater, thereby being capable of improving the recovery rate of the spilled oil.

The spilled oil recovery apparatus includes the filter 233 provided to surround the opening 231, and may thus secondarily perform oil-water separation through the filter 233 before the seawater is discharged from the spilled oil storage 200, thereby being capable of improving oil-water separation efficiency.

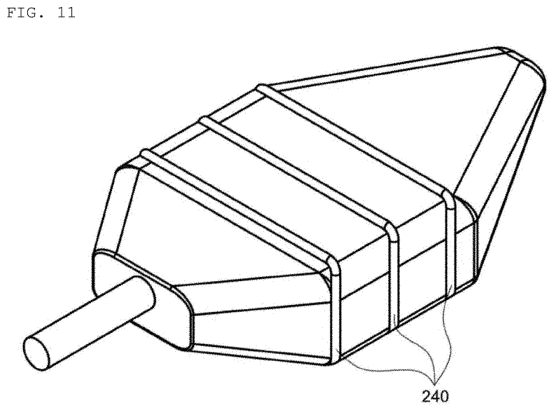

Thereafter, referring to FIG. 11, a spilled oil storage 200 of a spilled oil recovery apparatus according to an additional embodiment of the present invention will be described in more detail.

FIG. 11 is a perspective view showing the detailed configuration of the spilled oil storage 200 of the spilled oil recovery apparatus according to an additional embodiment of the present invention.

As shown in FIG. 11, the spilled oil storage 200 includes shape maintaining parts 240.

Here, the shape maintaining parts 240 are provided to surround the outer surface of the storage body 220 so as to maintain the shape of the storage body 220.

Further, the shape maintaining parts 240 extend in the height direction of the storage body 220, and are provided to surround the storage body 220 in the width direction thereof.

Here, at least one shape maintaining part 240 may be provided on the outer surface of the storage body 220.

The spilled oil recovery apparatus includes the shape maintaining parts 240 provided to surround the outer surface of the storage body 220, thereby being capable of preventing a risk of rollover of the spilled oil storage 200 caused by the spilled oil which fills up the storage body 220.

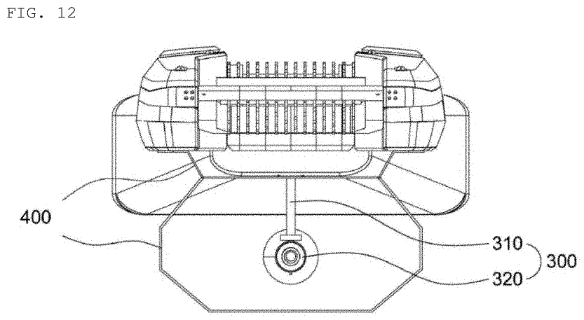

Thereafter, referring to FIG. 12, the propulsion unit 300 and the propulsion unit protection members 400 of the spilled oil recovery apparatus according to one embodiment of the present invention will be described in more detail.

FIG. 12 is a front view showing the propulsion unit 300 and the propulsion unit protection members 400 of the spilled oil recovery apparatus according to one embodiment of the present invention.

As shown in FIG. 12, the propulsion unit 300 includes a rotating shaft 310 and a propeller 320, and is provided to propel the spilled oil recovery apparatus.

The spilled oil recovery apparatus includes the propulsion unit 300 including the rotating shaft 310 and the propeller 320, and may thus be moved directly to a desired position in a desired direction through the propulsion unit 300 without using a separate towing device in the case in which the spilled oil recovery apparatus needs to be moved, thereby being capable of more effectively performing spilled oil recovery.

Further, the propulsion unit protection members 400 may be provided on the bottom surface of the body 100, and may be configured to surround the propulsion unit 300 so as to space the propulsion unit 300 apart from the ground.

Here, each of the propulsion unit protection members 400 may include an upper end part and a lower end part, and the upper end part may be provided such that the propulsion unit 300 may be fixedly coupled thereto while protecting the bottom surface of the body 100.

Further, the lower end part of each of the propulsion unit protection members 400 may surround the propulsion unit 300, and may be bent to form at least one angle so that respective sides surrounding the propulsion unit face each other.

The propulsion unit protection members 400 may be provided in plural, and the propulsion unit protection members 400 may be disposed to be spaced apart from each other by a designated distance.

The spilled oil recovery apparatus includes the propulsion unit protection members 400 provided to surround the propulsion unit 300, and the propulsion unit protection members 400 may function as a hydrofoil which maintains seawater flow around the body 100 when the spilled oil recovery apparatus floats on the sea, and simultaneously may serve to protect the propulsion unit 300 and lower structures even when the spilled oil recovery apparatus is stored in a land environment.

Thereafter, a spilled oil recovery apparatus 1000 according to another additional environment of the present invention may be includes an oil recovery system S based on monitoring information about a sea environment, and may be provided to float on the sea so as to recover spilled oil floating on the surface of the sea.

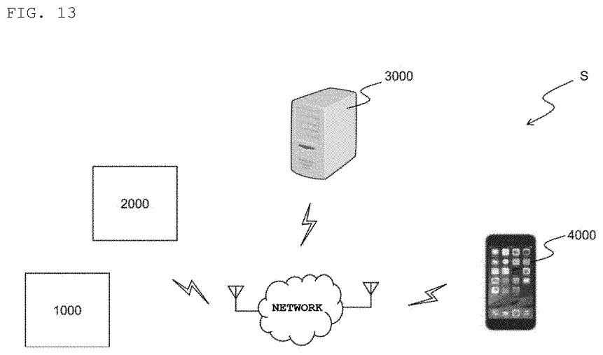

Referring to FIG. 13, the oil recovery system S based on monitoring information about the sea environment, including the spilled oil recovery apparatus 1000 according to another additional embodiment of the present invention, will be described in more detail.

FIG. 13 is a conceptual view showing the oil recovery system S including the spilled oil recovery apparatus 1000 according to another additional embodiment of the present invention.

As shown in FIG. 13, the spilled oil recovery apparatus 1000, a monitoring unit 2000, a service server 3000 and a user terminal 4000 may form the oil recovery system S.

Here, at least one monitoring unit 2000 may be provided to monitor the spilled state of spilled oil present on the surface of the sea while flying over the sea, and may thus collect monitoring information which is information about the spilled state of the spilled oil present on the surface of the sea.

Further, the service server 3000 may be constructed to be connected to at least one selected from among the spilled oil recovery apparatus 100 and the monitoring unit 2000, and to collect at least one piece of information acquired through the apparatus and/or the unit.

In addition, at least one user terminal 4000 may be provided to be connected to the service server 3000 so as to communicate therewith, and to output information collected by the service server 3000.

Here, the spilled oil recovery apparatus 1000 is connected to the service server 3000 so as to communicate therewith, receives various pieces of information from the service server 3000, and is operated based on the received information so as to perform recovery of the spilled oil.

Further, the spilled oil recovery apparatus 1000 may be connected to the user terminal 4000 so as to communicate therewith, may receive various pieces of information from the user terminal 4000, and may be operated based on the received information.

Here, a position information acquisition module including a Global Positioning System (GPS) module provided to acquire both current position information representing the current coordinates of the spilled oil recovery apparatus 1000 and the current position information of the monitoring unit 2000 provided through the monitoring unit 2000 is located on the spilled oil recovery apparatus 1000.

The GPS module receives position information from a plurality of artificial satellites. Here, the position information may include coordinate values represented by latitude and longitude.

For example, the GPS module may measure accurate times and distances from three or more satellites, and may accurately calculate a current position from three different distances using triangulation. Here, a method in which distance and time information are acquired from three satellites and an error is corrected using one satellite may be used. Particularly, the GPS module may acquire not only positions, such as latitudes, longitudes and altitudes, but also accurate time information together with three-dimensional velocity information, from position information received from the satellites.

Further, the spilled oil recovery apparatus 1000 may be operated in a different manner depending on whether or not the monitoring unit 2000 is operated.

In more detail, when it is determined that the monitoring unit 2000 is operable, and thus, the monitoring unit 2000 reaches an area in which recovery of spilled oil is required, the service server 3000 may collect the current position information of the monitoring unit 2000 and provide the current position information of the monitoring unit 2000 to the spilled oil recovery apparatus 1000, and then, the spilled oil recovery apparatus 1000 may be operated to be moved to the position, where the monitoring unit 200 is located, based on the received position information of the monitoring unit 2000.

Further, when it is determined that the monitoring unit 2000 is inoperable, the spilled oil recovery apparatus 1000 may be operated based on position information input through the user terminal 4000.

As described above, the spilled oil recovery apparatus 1000 may be operated based on information acquired through the monitoring unit 2000 and may be placed at an accurate position so as to reliably perform recovery of spilled oil, when the monitoring unit 2000 is operatable, and may be placed at a desired position through the user terminal 400 so as to stably perform recovery of the spilled oil, even in a situation in which the monitoring unit 2000 is inoperable.

As is apparent from the above description, a spilled oil recovery apparatus according to one embodiment of the present invention includes a body and a spilled oil storage, which are separated from each other, and may thus secure ease of maintenance of the respective elements, and may resume spilled oil recovery by replacing the spilled oil storage alone rather than the entirety of the spilled oil recovery apparatus when the spilled oil recovery apparatus is full of the spilled oil, thereby being capable of providing improvement in work efficiency.

The spilled oil recovery apparatus according to one embodiment of the present invention includes a spilled oil adsorber configured to be rotated, and thus, introduced oily water may be adsorbed onto the surface of the spilled oil separator through rotation thereof, thereby being capable of effectively drawing the oily water in a short time.

The spilled oil recovery apparatus according to one embodiment of the present invention includes the spilled oil adsorber detachably coupled to the body, and thus, the spilled oil adsorber may be selectively changed depending on the environment and the kind of the oily water, and may be detached from the body, thereby being capable of improving ease of maintenance.

The spilled oil recovery apparatus according to one embodiment of the present invention includes a scraper, and thus, the scraper may come into contact with the surface of the spilled oil adsorber and physically scrape out the spilled oil adsorbed onto the surface of the spilled oil adsorber so as to completely desorb the spilled oil from the spilled oil adsorber.

The spilled oil recovery apparatus according to one embodiment of the present invention and a spilled oil recovery apparatus according to another embodiment of the present invention includes the spilled oil adsorber selectively employing one of a first adsorber and a second adsorber, and may thus select and replace one of the first adsorber and the second adsorber as the spilled oil adsorber so as to be suitable for the environment and the kind of the oily water, thereby being capable of improving spilled oil recovery efficiency.

The spilled oil recovery apparatus according to one embodiment of the present invention includes the first adsorber including at least one dispersion member, and may thus physically disperse the spilled oil, thereby being capable of effectively performing oil-water separation even in an environment in which the viscosity of the spilled oil is high.

The spilled oil recovery apparatus according to another embodiment of the present invention includes the second adsorber formed in a cylindrical shape, and may thus effectively perform oil-water separation even in an environment in which the viscosity of the spilled oil is low.

The spilled oil recovery apparatus according to one embodiment of the present invention includes a propulsion unit including a rotating shaft and a propeller, and may thus be moved directly to a desired position in a desired direction through the propulsion unit without using a separate towing device in the case in which the spilled oil recovery apparatus needs to be moved, thereby being capable of more effectively performing spilled oil recovery.

The spilled oil recovery apparatus according to one embodiment of the present invention includes propulsion unit protection members provided to surround the propulsion unit, and the propulsion unit protection members may function as a hydrofoil which maintains seawater flow around the body when the spilled oil recovery apparatus floats on the sea, and simultaneously may serve to protect the propulsion unit and lower structures even when the spilled oil recovery apparatus is stored in a land environment.

The spilled oil recovery apparatus according to one embodiment of the present invention includes folding parts provided such that a storage body of the spilled oil storage is folded in the length direction along the folding parts, and may thus allow the spilled oil storage to be folded, thereby being capable of facilitating storage and transportation of the spilled oil storage.

The spilled oil recovery apparatus according to one embodiment of the present invention includes a discharge amount adjustment member provided to open and close an opening of the spilled oil storage, and may thus adjust the discharge amount of seawater by opening and closing the opening, thereby being capable of flexibly adjusting the amount of seawater discharged from the spilled oil recovery apparatus depending on a sea environment and condition and thus increasing propulsion efficiency of the spilled oil recovery apparatus.

The spilled oil recovery apparatus according to one embodiment of the present invention includes a filter provided to surround the opening, and may thus secondarily perform oil-water separation through the filter before the seawater is discharged from the spilled oil storage, thereby being capable of improving oil-water separation efficiency.

A spilled oil recovery apparatus according to an additional embodiment of the present invention includes shape maintaining parts, thereby being capable of preventing a risk of rollover of the spilled oil storage caused by the spilled oil which fills up a storage body.

A spilled oil recovery apparatus according to yet another embodiment of the present invention includes collection members provided to come into contact with the spilled oil adsorber, thereby being capable of improving individual contact areas of the collection members with the spilled oil adsorber and improving the recovery rate of the spilled oil adsorbed onto the side surfaces of the spilled oil adsorber.

The spilled oil recovery apparatus according to yet another embodiment of the present invention includes collection channels provided to transfer the collected spilled oil towards a temporary spilled oil storage, and may thus form flow paths for the spilled oil collected by the collection members, thereby being capable of preventing the spilled oil from leaking to other regions and improving the recovery rate of the spilled oil.

While the invention has been explained in relation to its embodiments, it is to be understood that various modifications or equivalents thereof will become apparent to those skilled in the art upon reading the specification.

Therefore, it is to be understood that the invention disclosed herein is intended to cover such modifications as fall within the scope of the appended claims.

What is claimed is:

1. A spilled oil recovery apparatus comprising:
a body configured to provide buoyancy so that the spilled oil recovery apparatus floats on a surface of sea, and to separate oily water comprising a mixture of seawater and spilled oil into the seawater and the spilled oil; and
a spilled oil storage comprising a storage body connected to the body so as to store recovered spilled oil,
wherein the body comprises:
an oily water inlet configured to form a space having a designated area at one end of the body so that the oily water on the sea is introduced into the oily water inlet;
a spilled oil separator provided to communicate with the oily water inlet so as to separate the spilled oil from the introduced oily water; and
a temporary spilled oil storage configured to receive the spilled oil from the spilled oil separator and to transfer the spilled oil to the spilled oil storage.

2. The spilled oil recovery apparatus according to claim 1, wherein the spilled oil separator comprises:
a spilled oil adsorber provided to come into contact with the oily water introduced through the oily water inlet and to be rotated so as to selectively adsorb the spilled oil floating on a surface of the oily water; and
a scraper provided to come into contact with the spilled oil adsorber and to cover the spilled oil adsorber so as to scrape out the spilled oil adsorbed onto a surface of the spilled oil adsorber and thus to desorb the spilled oil from the spilled oil adsorber,
wherein the spilled oil adsorber is detachably coupled to the body.

3. The spilled oil recovery apparatus according to claim 2, wherein the spilled oil separator is one selected from a first adsorber and a second adsorber,
wherein the first adsorber and the second adsorber are configured such that a specific gravity of spilled oil adsorbed by the first adsorber is higher than a specific gravity of spilled oil adsorbed by the second adsorber.

4. The spilled oil recovery apparatus according to claim 3, wherein the first adsorber comprises at least one dispersion member configured to disperse the spilled oil in an agglomerated state, and, when a plurality of dispersion members is provided, the dispersion members are disposed to be spaced apart from each other by a designated distance so that protrusions thereof alternate with each other.

5. The spilled oil recovery apparatus according to claim 3, wherein the second adsorber is formed in a cylindrical shape, and is configured to be rotated while adsorbing the spilled oil on an outer circumferential surface thereof.

6. The spilled oil recovery apparatus according to claim 1, further comprising:
a propulsion unit provided to propel the spilled oil recovery apparatus; and
propulsion unit protection members provided on a bottom surface of the body, and configured to surround the propulsion unit so as to space the propulsion unit apart from ground.

7. The spilled oil recovery apparatus according to claim 1, wherein the storage body comprises:
at least one folding part provided to fold the storage body in a direction of reducing a length of extension thereof.

8. The spilled oil recovery apparatus according to claim 1, wherein the spilled oil storage comprises:
a seawater outlet formed in a bottom surface of the spilled oil storage so as to discharge seawater present in the spilled oil stored in the spilled oil storage,
wherein the seawater outlet comprises:
an opening configured to form an open space having a designated area so that the spilled oil storage communicates with outside therethrough; and
a discharge amount adjustment member provided to vary an open area of the opening so as to adjust an amount of seawater discharged through the opening.

9. The spilled oil recovery apparatus according to claim 8, wherein the spilled oil outlet further comprises:
a filter provided to surround the opening so as to filter out oil present in the seawater discharged from the spilled oil storage.

10. The spilled oil recovery apparatus according to claim 1, wherein the spilled oil storage comprises:
shape maintaining parts provided to surround an outer surface of the storage body so as to maintain a shape of the storage body.

11. The spilled oil recovery apparatus according to claim 2, wherein the scraper comprises:
a scraper body formed to cover the spilled oil adsorber;
at least one collection member coupled to the scraper body and provided to come into contact with the spilled oil adsorber; and
at least one collection channel provided on the scraper body so as to gather and transfer the spilled oil collected by the at least one collection member towards the temporary spilled oil storage.
